(19) United States
(12) Patent Application Publication
(10) Pub. No.: US 2026/0339962 A1
(43) Pub. Date: Oct. 29, 2026

(54) SYSTEMS AND METHODS FOR MANAGING CLASSIFICATION AND RETRIEVAL OF DATA ASSOCIATED WITH A FACILITY

(71) Applicant: Honeywell International Inc., Charlotte, NC (US)

(72) Inventors: Ankit Hotchandani, Bangalore (IN); Ashwath Kakde, Bangalore (IN); Pavithra K, Bangalore (IN); Abhishek Mukunda Rao, Bangalore (IN)

(21) Appl. No.: 19/188,059

(22) Filed: Apr. 24, 2025

(51) Int. Cl. G06F 16/2457; G06F 16/21; G06F 16/22; G06F 16/248

(52) U.S. Cl. CPC G06F 16/24578; G06F 16/211; G06F 16/2237; G06F 16/248

(57) ABSTRACT

Various embodiments described herein relate to systems and methods for managing classification and retrieval of data associated with a facility. In this regard, schema details of each of a plurality of databases associated with the facility is extracted. Then, the schema details are transformed into one or more first vectorial representations. A query from a user associated with the facility is received via a user interface. This query is converted into a second vectorial representation. The second vectorial representation is compared with the one or more first vectorial representations. Further, a ranked list of one or more databases having information related to the query is generated. Furthermore, one or more responses to the query are also rendered via the user interface such that the one or more responses are based on the information in the one or more databases.

### TECHNICAL FIELD

The present disclosure generally relates to a data management system. More particularly, the present disclosure relates to managing data classification and data retrieval in a facility.

### BACKGROUND

Typically, a facility (such as an industrial plant, a manufacturing unit, a processing factory, and/or the like) includes numerous assets or equipment. Some of these assets may be, but not limited to boilers, chillers, pumps, sensors, air handling units (AHUs), variable refrigerant flow (VRF) systems, blenders, furnaces, and/or the like. Often such assets are employed to facilitate various processes in the facility. For instance, a specific set of assets may operate to facilitate certain processes, such as blending operations to produce say, petroleum products from naphtha. Accordingly, numerous such processes are undertaken on a day-to-day basis using the assets employed in the facility. Given that the number of assets along with the processes is quite substantial, data generated from each of the assets (i.e., industrial data related to the assets and/or the processes) is also quite humongous. At times, record of such data may be stored in multiple databases or storage solutions, which may be disjoint or disparate in nature. With such an arrangement, retrieval of a particular portion of the data from disjoint sources for a specific ask, say from an operator in the facility becomes arduous using traditional applications. Therefore, management of such industrial data in multiple databases or storage solutions becomes a challenging task.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple facilities, in accordance with one or more example embodiments described herein.

FIG. 2 illustrates a schematic diagram showing an implementation of a controller that may execute techniques in accordance with one or more example embodiments described herein.

FIG. 3 illustrates a schematic diagram showing an implementation of an exemplary data management system, in accordance with one or more example embodiments described herein.

FIG. 4 illustrates a schematic diagram showing an exemplary flow diagram associated with one or more operations of exemplary data management system, in accordance with one or more example embodiments described herein.

FIG. 5 illustrates a schematic diagram showing an exemplary user interface associated with an exemplary data management system, in accordance with one or more example embodiments described herein.

FIG. 6 illustrates a flowchart showing a method described in accordance with one or more example embodiments described herein.

FIG. 7 illustrates a flowchart showing a method described in accordance with one or more example embodiments described herein.

FIG. 8 illustrates a flowchart showing a method described in accordance with one or more example embodiments described herein.

FIG. 9 illustrates a flowchart showing a method described in accordance with one or more example embodiments described herein.

FIG. 10 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for managing classification and retrieval of data associated with a facility is described herein. In this regard, the method comprises extracting one or more schema details of each of a plurality of databases associated with the facility. Further, the method comprises transforming the one or more schema details of each of the plurality of databases into one or more first vectorial representations. Then, the method comprises receiving a query from a user associated with the facility via a user interface. The method also comprises converting the query received from the user into a second vectorial representation. Upon converting the query into the second vectorial representation, the method comprises comparing the second vectorial representation with the one or more first vectorial representations. Then, the method comprises generating a ranked list of one or more databases based on the comparing. In this regard, the one or more databases comprise information related to the query received from the user. Additionally, the method comprises rendering one or more responses to the query received from the user via the user interface. It is to be noted that the one or more responses are based on the information in the one or more databases.

In accordance with another embodiment of the current disclosure, a system for managing classification and retrieval of data associated with a facility is described herein. The system comprises a processor and a memory communicatively coupled to the processor, wherein the memory comprises one or more instructions which when executed by the processor, cause the processor to extract one or more schema details of each of a plurality of databases associated with the facility. The processor is also configured to transform the one or more schema details of each of the plurality of databases into one or more first vectorial representations. Further, the processor is configured to receive a query from a user associated with the facility via a user interface. Also, the processor is configured to convert the query received from the user into a second vectorial representation. Then, the processor is configured to compare the second vectorial representation with the one or more first vectorial representations. The processor is also configured to generate a ranked list of one or more databases based on the comparing such that the one or more databases comprise information related to the query received from the user. Additionally, the processor is also configured to render one or more responses to the query received from the user via the user interface. It is to be noted that the one or more responses are based on the information in the one or more databases.

In accordance with yet another embodiment of the current disclosure, a non-transitory, computer-readable storage medium having instructions stored thereon and executable by one or more processors is described herein. In this regard, the instructions when executed by one or more processors cause the one or more processors to extract one or more schema details of each of a plurality of databases associated with the facility. The one or more processors are also configured to transform the one or more schema details of each of the plurality of databases into one or more first vectorial representations. Further, the one or more processors are configured to receive a query from a user associated with the facility via a user interface. Also, the one or more processors are configured to convert the query received from the user into a second vectorial representation. Then, the one or more processors are configured to compare the second vectorial representation with the one or more first vectorial representations. The one or more processors are also configured to generate a ranked list of one or more databases based on the comparing such that the one or more databases comprise information related to the query received from the user. Additionally, the one or more processors are also configured to render one or more responses to the query received from the user via the user interface. It is to be noted that the one or more responses are based on the information in the one or more databases.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

More particularly, a facility involves several personnel such as plant managers, process engineers, production engineers, chief experience officers (CXOs), plant operators, and/or the like. Often, such personnel interact with various applications in the facility to view information related to asset(s) and/or process(es) in the facility. That is, the personnel may try to seek information such as, facts/details related to contextual production, several key performance indicators/metrics, and/or the like. For the applications to provide such information, data related to various assets and/or processes associated with the facility serve as the source. Provided that such data related to assets and/or processes in the facility is quite extensive, the facility often relies on multiple storage solutions to store the data. So, the facility may store such industrial data in multiple databases or other storage solutions, which may be disjoint or disparate. This may be often done in view of optimal usage of computing resources such as, memory. However, storing industrial data in such disparate storages may have associated shortcomings. For instance, personnel such as a plant manager may be looking out for underperforming key performance indicators related to a particular process in a plant. So, the plant manager may provide a query related to the same to appropriate applications. But specific data relevant to underperforming key performance indicators of said particular process may be stored in say, two different databases. That is, a first portion of data may be stored in a first database while a second portion of data may be stored in a second database. Traditionally, such applications may fail to consider inter-relationship(s) between portions of data stored in said different databases and/or retrieve specific data from said databases in order to provide appropriate information as a response to the personnel. With this, traditional applications may fail to provide appropriate key performance indicators to the personnel. Additionally, such traditional applications may merely provide a few dashboards with minimal information related to particular asset(s) and/or particular process(es). That is, such dashboards provided by traditional applications may be limited to a fixed set of queries for retrieval of specific data in order to provide appropriate response(s) to the personnel. In view of such shortcomings, retrieval of relevant industrial data becomes tough in order to provide appropriate information related to asset(s) and/or process(es) in the facility to the personnel.

Thus, to address the above challenges, various examples of systems and methods described herein employ various techniques based on artificial intelligence (AI) and/or machine learning (ML) to efficiently manage data classification and data retrieval in a facility. The data associated with the facility may correspond to industrial data related to assets and/or processes in the facility. In this regard, for instance, the system described herein is configured to query database(s) using a vector-based approach. That is, the system creates and utilizes vector-based classifications of database schema(s) along with queries received to query database(s). The queries may be often received from users such as personnel associated with the facility. With such an approach, querying multiple databases and retrieving relevant data from such databases turns out to be a streamlined process which also enhances efficiency of querying across multiple databases.

Initially, the system extracts one or more schema details of each of a plurality of databases associated with the facility. The plurality of databases stores the industrial data related to assets and/or processes in the facility. In view of extracting the one or more schema details, the system initially collects relevant schema details from each of the plurality of databases. The one or more collected schema details for each database may comprise one or more table names, one or more column names, one or more data types, one or more schema descriptions, and/or the like. Then, the system normalizes the one or more collected schema details associated with each of the plurality of databases. That is, the system may normalize the one or more schema descriptions. Also, the system may normalize the one or more table names, the one or more column names, the one or more data types, and/or the like associated with each of the plurality of databases in addition to normalizing the one or more schema descriptions. So, the normalized version of the one or more table names, the one or more column names, the one or more data types, the one or more schema descriptions, and/or the like corresponds to the one or more schema details. The system performs such normalization in order to ensure and maintain consistency of schema details across different databases. Further, the system also stores the one or more schema details derived upon normalization in suitable storage(s) as a part of extracting the one or more schema details.

Then, the system transforms the one or more schema details of each of the plurality of databases into one or more first vectorial representations. To transform the one or more schema details into the one or more first vectorial representations, the system described herein initially selects a suitable technique of one or more techniques which may be used to derive appropriate first vectorial representations. For example, a technique on which the system may rely on may correspond to a text embedding model (for example, an ADA text embedding model). Upon selection of such suitable technique, the system converts one or more textual representations in each of the one or more schema details for a database into appropriate set of vectorial representations. That is, the one or more schema details may comprise one or more textual representations indicating table name(s), column name(s), data type(s), schema description(s), and/or the like for the database. So, the system may convert each textual representation indicating table name(s) into a first set of vectorial representations while the system may convert each textual representation indicating column name(s) into a second set of vectorial representations. Further, the system may convert each textual representation indicating data type(s) into a third set of vectorial representations while the system may convert each textual representation indicating schema description(s) into a fourth set of vectorial representations. Upon converting such textual representations into appropriate set of vectorial representations, the system aggregates such set of vectorial representations to derive a first vectorial representation for the database. Similarly, the system may aggregate respective set of vectorial representations for other database(s) from amongst the plurality of databases in order to derive corresponding first vectorial representation for each of the plurality of databases. Further, the system stores the one or more first vectorial representations in suitable storage(s) as well. It is to be appreciated that the plurality of databases may comprise those databases which are disjoint or disparate in nature.

Then, the system described herein receives a query from a user associated with the facility via a user interface. The query may be related to particular assets and/or particular processes in the facility while the user may correspond to personnel such as plant managers, process engineers, production engineers, chief experience officers (CXOs), plant operators, and/or the like. Upon receiving the query from the user, the system converts the query into a second vectorial representation. This conversion may be based on the same technique selected by the system to derive the one or more first vectorial representations. Upon converting the query into the second vectorial representation, the system compares the second vectorial representation with the one or more first vectorial representations. In this regard, the system applies a similarity measure (cosine similarity) in view of comparing the second vectorial representation against the one or more first vectorial representations. While comparing the second vectorial representation against each of the one or more first vectorial representations, the system determines one or more similarity scores as well. Further, in response to the comparison, the system generates a ranked list of one or more databases. In this regard, the system may identify that the one or more databases closely align with the query received from the user. More particularly, the one or more databases are identified based on the one or more similarity scores as potential database(s) as they comprise information related to the query received from the user. Based on the ranked list, the system retrieves the information from the one or more databases. Then, the system provides one or more responses to the query received from the user. These responses are framed based on the information retrieved from the one or more databases. Also, the one or more responses are rendered via the user interface for the query received from the user. It should be appreciated that the one or more responses are validated before providing it to the user. This is to make sure that the responses provided by the system are of utmost accuracy and to avoid situations like hallucinations. Also, the system stores history of queries received from the user along with their corresponding responses and learns from such history over time to improvise quality of responses.

Thus, the foregoing vector-based data classification and data retrieval approach enables efficient and accurate identification of relevant database(s) to facilitate improved querying experience for users in the facility. By focusing on vectorization, the system avoids the need for processing large amounts of data and effectively streamlines classification of user queries in multi-database environments which are disparate in nature.

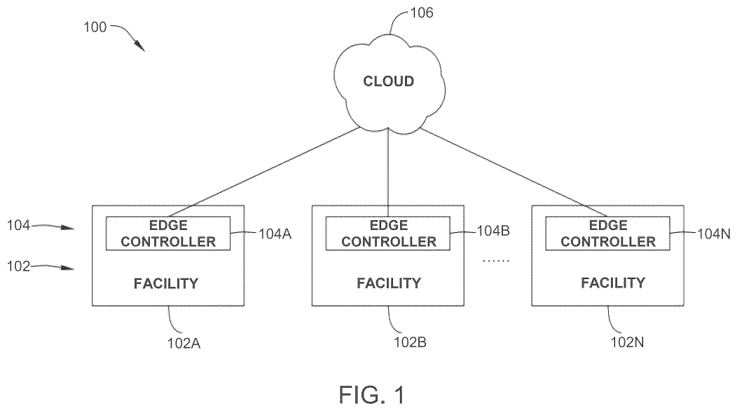

FIG. 1 illustrates a schematic diagram showing an exemplary environment comprising multiple facilities. According to various example embodiments described herein, an exemplary environment 100 comprises one or more facilities 102a, 102b, . . . 102n (collectively “facilities 102”). In some example embodiments, a facility of the one or more facilities 102a, 102b, . . . 102n may correspond to, for example, an industrial plant, a manufacturing unit, a processing factory, and/or the like. In some example embodiments, the one or more facilities 102a, 102b, . . . 102n in the illustrative environment 100 may be of same type. In some example embodiments, the one or more facilities 102a, 102b, . . . 102n in the illustrative environment 100 may be of different type. As it may be understood, in some example embodiments described herein, the facilities 102 often include one or more assets that facilitate numerous processes in the facilities 102. For example, a facility may include several assets such as boilers, chillers, pumps, sensors, air handling units (AHUs), variable refrigerant flow (VRF) systems, blenders, furnaces, and/or the like to facilitate several processes in the facility. For example, a specific set of assets may operate to facilitate certain processes, such as blending operations to produce say, petroleum products from naphtha. In another example, yet another set of assets may operate to facilitate one or more filter washing processes.

In some example embodiments, a cloud 106 is operably coupled with one or more facilities 102a, 102b, . . . 102n, meaning that communication between the cloud 106 and one or more facilities 102a, 102b, . . . 102n is enabled. The cloud 106 may represent distributed computing resources, software, platform or infrastructure services which can enable data handling, data processing, data management, and/or analytical operations on data exchanged & transacted amongst various assets of the facilities 102. Specifically, in some example embodiments described herein, the cloud 106 may comprise one or more services to manage the data. This data may often correspond to industrial data associated with various assets and/or various processes in the facility. That is, the data may comprise telemetry data (e.g. sensor data from one or more sensors associated with respective assets, process data associated with corresponding process(es) handled by respective assets, and/or the like) along with contextual data (e.g. geographical location of asset(s), category/type of asset(s), category/type of process(es) handled by asset(s), and/or the like). Telemetry data can include time stamps and data values corresponding to those time stamps. In other words, telemetry data can represent data collected over a period of time (e.g. continuous data stream captured over a time period) say, from various assets (e.g. sensors, IoT network) of the facilities 102. In some examples, the data at the cloud 106 may additionally comprise operational data (OT data) and information technology (IT) enabled data which may be received and/or transacted through the facilities 102. In some example embodiments described herein, the one or more services of the cloud 106 generally facilitate generation of one or more models for the facilities 102 to manage data classification and data retrieval as per requirements of users in the facilities 102. In this regard, the cloud 106 may utilize the one or more models to manage the data associated with facilities 102 in order to achieve effective overall management of the facilities 102 as well.

In some example embodiments, the cloud 106 includes one or more servers that may be programmed to communicate with the one or more facilities 102a, 102b, . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower-level computer server (or servers) processes the data, for example, while a higher-level computer server oversees operation of the lower-level computer server or servers.

The one or more facilities 102a, 102b, . . . 102n may include a variety of different assets. In some example embodiments, the one or more facilities 102a, 102b, . . . 102n may include a variety of different assets, at least some of which are of same type. In some example embodiments, the one or more facilities 102a, 102b, . . . 102n may include a variety of different assets, at least some of which are of different type. In the example shown in FIG. 1, each of the one or more facilities 102a, 102b, . . . 102n includes a respective edge controller (alternatively, edge gateway) 104a, 104b, . . . 104n (collectively “edge controllers 104” or “edge gateways 104”). In some example embodiments, each of one or more edge controllers 104a, 104b, . . . 104n is configured to receive data from a variety of assets or their associated sensors within the one or more facilities 102a, 102b, . . . 102n. In some examples, the one or more edge controllers 104a, 104b, . . . 104n may operate as intermediary node to transact data through one or more assets of the facilities 102 and/or to the cloud 106. In some examples, each of the one or more edge controllers 104a, 104b, . . . 104n is capable of receiving the data from disparate data sources e.g., but not limited to, in different data formats and/or using various data communication protocols, from assets of the facilities 102. In this regard, each of the one or more edge controllers 104a, 104b, . . . 104n can receive & filter the data and translate the data into a common language and/or format (e.g. normalized data) for subsequent communication to the cloud 106. The common language and/or format may be compatible with and expected by the cloud 106.

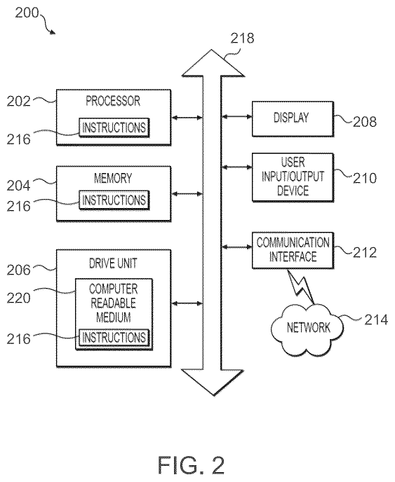

FIG. 2 illustrates a schematic diagram showing an implementation of a controller that may execute techniques in accordance with one or more example embodiments described herein. In one or more example embodiments, controller 200 described herein may include a set of instructions that can be executed to cause the controller 200 to perform any one or more of the methods or computer-based functions disclosed herein. The controller 200 may operate as a standalone device or may be connected, e.g., using a network, to other computer systems or peripheral devices.

In a networked deployment, the controller 200 may operate in the capacity of a server or as a client in a server-client user network environment, or as a peer computer system in a peer-to-peer (or distributed) network environment. The controller 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 200 can be implemented using electronic devices that provide voice, video, or data communication. Further, while the controller 200 is illustrated as a single system, the term “system” shall also be taken to include any collection of systems or sub-systems that individually or jointly execute a set, or multiple sets, of instructions to perform one or more computer functions.

As illustrated in FIG. 2, the controller 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The controller 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the controller 200 may include an input/output device 210 configured to allow a user to interact with any of the components of controller 200. The input/output device 210 may be a number pad, a keyboard, or a cursor control device, such as a mouse, or a joystick, touch screen display, remote control, or any other device operative to interact with the controller 200. The controller 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the controller 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in controller 200, or combinations thereof. The connection with the network 214 may be a physical connection, such as a wired Ethernet connection or may be established wirelessly as discussed below. Likewise, the additional connections with other components of the controller 200 may be physical connections or may be established wirelessly. The network 214 may alternatively be directly connected to a bus 218.

While the computer-readable medium 220 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

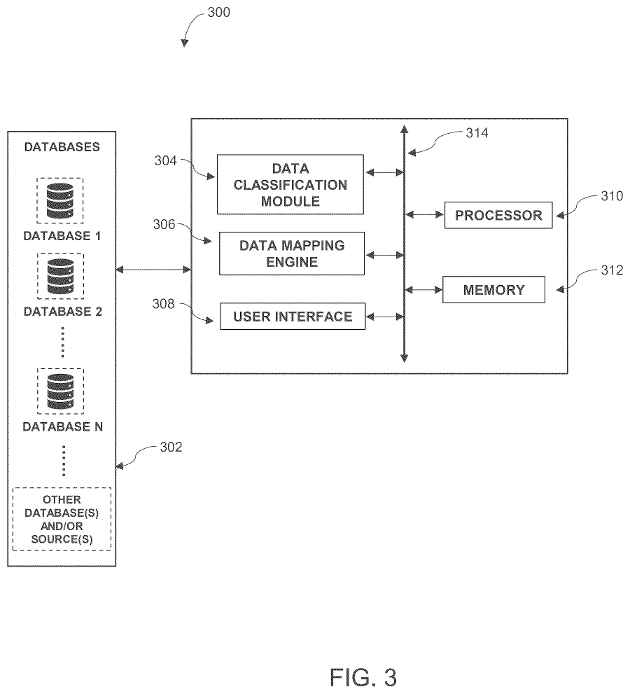

FIG. 3 illustrates a schematic diagram showing an implementation of an exemplary data management system, in accordance with one or more example embodiments described herein. In one or more example embodiments, the data management system 300 described herein utilizes vector-based approach to classify database schema(s) and queries received from users to query database(s) associated with a facility (for instance, one or more facilities 102a, 102b, . . . 102n as described in FIG. 1 of the current disclosure). Such an approach facilitates effective retrieval of relevant information from appropriate database(s) based on user queries. The database(s) often store data associated with the facility and this data may correspond to industrial data related to assets and/or processes in the facility. More specifically, the data management system 300 initially extracts schema detail(s) of each of a plurality of databases associated with the facility such that the plurality of databases stores the industrial data. That is, the data management system 300 collects relevant schema details and normalizes the collected schema details of each of the plurality of databases to extract the schema detail(s). Further, the data management system 300 transforms the schema detail(s) of each of the plurality of databases into first vectorial representation(s). In this regard, the data management system 300 selects a suitable technique which may be used to derive appropriate first vectorial representation(s). Then, the data management system 300 facilitates conversion of the schema detail(s) into the first vectorial representation(s) based on the selected technique. In the meantime, the data management system 300 may receive a query from a user associated with the facility via a user interface. The query may be related to particular assets and/or particular processes in the facility. The data management system 300 then converts the received query into a second vectorial representation. This may be based on the same technique selected by the data management system 300 to derive the first vectorial representation(s). Furthermore, the data management system 300 compares the second vectorial representation with the first vectorial representation(s) to determine similarity score(s). Based on the similarity score(s), the data management system 300 identifies one or more databases which closely align with the query received from the user. Per this aspect, the data management system 300 generates a list of the one or more databases which is ranked. Based on such list, the data management system 300 retrieves information from the one or more databases and frames response(s) to the query based on the information. Also, the data management system 300 renders the response(s) to the query via the user interface.

In some example embodiments, the data management system 300 is a server system (e.g., a server device) that facilitates a data analytics platform between one or more computing devices, one or more data sources, and/or one or more facilities. In some example embodiments, the data management system 300 is a device with one or more processors and a memory. Also, in some example embodiments, the data management system 300 is implementable via the cloud 106. The data management system 300 is implementable in one or more facilities related to one or more technologies, for example, but not limited to, enterprise technologies, connected building technologies, industrial technologies, Internet of Things (IOT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, life science technologies, process plant technologies, procurement technologies, and/or one or more other technologies.

In some example embodiments, the data management system 300 comprises one or more components such as, a data classification module 304, a data mapping engine 306, and/or a user interface 308. Additionally, in one or more example embodiments, the data management system 300 comprises a processor 310 and/or a memory 312. In one or more example embodiments, one or more components of the data management system 300 may be communicatively coupled to the processor 310 and/or the memory 312 via a bus 314. Also, in one or more example embodiments described herein, the data management system 300 may be communicatively coupled with a plurality of databases 302. In this regard, the data management system 300 may be communicatively coupled with the plurality of databases 302 through wired or wireless means. In certain example embodiments, one or more aspects of the data management system 300 (and/or other systems, apparatuses and/or processes disclosed herein) constitute executable instructions embodied within a computer-readable storage medium (e.g., the memory 312). For instance, in an example embodiment, the memory 312 stores computer executable component and/or executable instructions (e.g., program instructions). Furthermore, the processor 310 facilitates execution of the computer executable components and/or the executable instructions (e.g., the program instructions). In an example embodiment, the processor 310 is configured to execute instructions stored in the memory 312 or otherwise accessible to the processor 310.

The processor 310 is a hardware entity (e.g., physically embodied in circuitry) capable of performing operations according to one or more embodiments of the disclosure. Alternatively, in an example embodiment where the processor 310 is embodied as an executor of software instructions, the software instructions configure the processor 310 to perform one or more algorithms and/or operations described herein in response to the software instructions being executed. In an example embodiment, the processor 310 is a single core processor, a multi-core processor, multiple processors internal to the data management system 300, a remote processor (e.g., a processor implemented on a server), and/or a virtual machine. In certain example embodiments, the processor 310 is in communication with the memory 312, the data classification module 304, the data mapping engine 306, and/or the user interface 308 via the bus 314 to, for example, facilitate transmission of data between the processor 310, the memory 312, the data classification module 304, the data mapping engine 306, and/or the user interface 308. In some example embodiments, the processor 310 may be embodied in a number of different ways and, in certain example embodiments, includes one or more processing devices configured to perform independently. Additionally or alternatively, in one or more example embodiments, the processor 310 includes one or more processors configured in tandem via bus 314 to enable independent execution of instructions, pipelining of data, and/or multi-thread execution of instructions. It is to be appreciated that the user interface 308 may also correspond to an interface of one or more computing devices associated with users in the facility.

The memory 312 is non-transitory and includes, for example, one or more volatile memories and/or one or more non-volatile memories. In other words, in one or more example embodiments, the memory 312 is an electronic storage device (e.g., a computer-readable storage medium). The memory 312 is configured to store information, data, content, one or more applications, one or more instructions, or the like, to enable the data management system 300 to carry out various functions in accordance with one or more embodiments disclosed herein. In accordance with some example embodiments described herein, the memory 312 may correspond to an internal or external memory of the data management system 300. In some examples, the memory 312 may correspond to a database communicatively coupled to the data management system 300. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the data classification module 304 of the data management system 300 initially extracts one or more schema details of each of the plurality of databases 302 associated with the facility. In one or more example embodiments, the plurality of databases 302 described herein may comprise database 1, database 2, . . . database N along with other database(s) and/or source(s) as appropriate. The plurality of databases 302 often store the data associated with the facility and this data may correspond to industrial data related to assets and/or processes in the facility (as described in FIG. 1 of the current disclosure). That is, the data in the plurality of databases 302 may comprise telemetry data, contextual data, relevant metadata, and/or other appropriate data associated with assets and/or processes in the facility. It is to be noted that the industrial data associated with the facility may be stored in the plurality of databases 302 in a distributed manner. That is, for instance, a first portion of the data may be stored in a first database while a second portion of the data different from the first portion may be stored in a second database different from the first database. For example, telemetry data associated with a set of assets may be stored in a first database which may correspond to a time series database while contextual data associated with the same set of assets may be stored in a second database which may correspond to a relational database. Also, it is to be appreciated that database(s) in the plurality of databases 302 may be disparate in nature. That is, a database in the plurality of databases 302 may be different from another database in the plurality of databases 302. For example, a first database from amongst the plurality of databases 302 may be different when compared to few other databases in the plurality of databases 302. More particularly, a database may be relatively different from another database in view of one or more factors such as type of database, storage capacity of database, structure of storage in database, purpose of database, and/or the like. In this regard, database(s) in the plurality of databases 302 may correspond to a variety of databases such as, but not limited to time series database, relational database, graph database, and/or the like.

To extract the one or more schema details of each of the plurality of databases 302 associated with the facility, the data classification module 304 initially collects relevant schema details from each of the plurality of databases 302. The one or more collected schema details for each database from amongst the plurality of databases 302 may comprise details such as, but not limited to one or more table names, one or more column names, one or more data types, one or more schema descriptions, and/or the like. In some example embodiments, the data classification module 304 may interrogate/inquire each of the plurality of databases 302 to collect relevant schema details. While in some example embodiments, users associated with the facility may provide relevant schema details for each database from amongst the plurality of databases 302. Further, the data classification module 304 normalizes the one or more collected schema details associated with each of the plurality of databases 302. In this regard, the data classification module 304 may initially normalize the one or more schema descriptions. Then, the data classification module 304 may normalize the one or more table names, the one or more column names, the one or more data types, and/or the like associated with each of the plurality of databases 302. The data classification module 304 performs such normalization in order to ensure and maintain consistency of schema details across different database(s) of the plurality of databases 302. At this point, the data management system 300 obtains normalized version of the one or more table names, the one or more column names, the one or more data types, the one or more schema descriptions, and/or the like for each database from amongst the plurality of databases 302. Such normalized version of the one or more table names, the one or more column names, the one or more data types, the one or more schema descriptions, and/or the like corresponds to the one or more schema details extracted by the data classification module 304. Also, the data classification module 304 makes sure to store the one or more schema details in suitable storage(s) as well.

Then, in one or more example embodiments, the data classification module 304 transforms the one or more schema details of each of the plurality of databases into one or more first vectorial representations. In this regard, the data classification module 304 initially selects a suitable technique of one or more techniques which may be used to derive appropriate first vectorial representations. For example, a technique on which the data classification module 304 may rely on may correspond to a text embedding model (for example, an ADA text embedding model). Said alternatively, the data classification module 304 may use the ADA text embedding model to derive appropriate first vectorial representations. It is to be appreciated that the data classification module 304 may also rely on other suitable model(s) or framework(s) in conjunction with the selected technique to derive appropriate first vectorial representations. Upon selection of such suitable technique, the data classification module 304 converts one or more textual representations in each of the one or more schema details into one or more set of vectorial representations for each of the plurality of databases 302. More particularly, the one or more schema details extracted for say, a database of the plurality of databases 302 often comprises textual representation(s) such as, but not limited to table name(s), column name(s), data type(s), schema description(s), and/or the like. The data classification module 304 converts such textual representation(s) into appropriate set(s) of vectorial representations. That is, the data classification module 304 may convert each textual representation indicating table name(s) into a first set of vectorial representations while the data classification module 304 may convert each textual representation indicating column name(s) into a second set of vectorial representations. Further, the data classification module 304 may convert each textual representation indicating data type(s) into a third set of vectorial representations while the data classification module 304 may convert each textual representation indicating schema description(s) into a fourth set of vectorial representations. Upon converting such textual representations into appropriate set(s) of vectorial representations, the data classification module 304 aggregates said set of vectorial representations to derive a first vectorial representation for the database. Similarly, the data classification module 304 aggregates respective set of vectorial representations for other database(s) from amongst the plurality of databases 302 in order to derive corresponding first vectorial representation for each of the plurality of databases 302. Also, the data classification module 304 makes sure to store the one or more first vectorial representations in suitable storage(s) as well.

Further, in one or more example embodiments, the data management system 300 receives a query from a user associated with the facility. The query from the user at the data management system 300 is often received via the user interface 308. Generally, the query may be related to particular assets and/or particular processes in the facility. Whereas the user may correspond to personnel such as plant managers, process engineers, production engineers, chief experience officers (CXOs), plant operators, and/or the like associated with the facility. The query received from the user often comprises representation(s) which may be, but not limited to text, images, pictures, numbers, and/or like. Also, it is to be noted that the query may be received as visual input(s), auditory input(s), and/or tactile input(s) at the data management system 300 via the user interface 308. Upon receiving the query from the user, in one or more example embodiments described herein, the data classification module 304 converts the query into a second vectorial representation. In this regard, the data classification module 304 converts the representation(s) in the query into the second vectorial representation. It is to be noted that the data classification module 304 may convert the representation(s) in the query into the second vectorial representation based on the same technique selected by the data classification module 304 to derive the one or more first vectorial representations.

Upon converting the query into the second vectorial representation, in one or more example embodiments, the data mapping engine 306 of the data management system 300 compares the second vectorial representation with the one or more first vectorial representations. In this regard, the data mapping engine 306 compares the second vectorial representation with each of the one or more first vectorial representations. For such comparison, the data mapping engine 306 applies a similarity measure to compare the second vectorial representation against each of the one or more first vectorial representations. The similarity measure used by the data mapping engine 306 may correspond to, for example, cosine similarity. It is to be noted that the data mapping engine 306 may also additionally or alternatively use other relevant approach(es) similar to cosine similarity for comparing the second vectorial representation against each of the one or more first vectorial representations. Based on the comparison of the second vectorial representation against each of the one or more first vectorial representations, the data mapping engine 306 determines one or more similarity scores. That is, the data mapping engine 306 determines a respective similarity score upon comparison of the second vectorial representation with a corresponding first vectorial representation from amongst the one or more first vectorial representations. It is to be noted that a similarity score from amongst the one or more similarity scores indicates a degree of semantic similarity between the second vectorial representation and a corresponding first vectorial representation with which the second vectorial representation is compared. While comparing, the data mapping engine 306 may consider certain predefined criteria to assess semantic similarity in order to determine the one or more similarity scores as well.

Based on such comparing, in one or more example embodiments, the data mapping engine 306 then generates a ranked list of the one or more databases. The data mapping engine 306 generates such ranked list based on the one or more similarity scores. That is, the data mapping engine 306 identifies that the one or more databases comprise information related to the query received from the user based on the one or more similarity scores. Said alternatively, the data mapping engine 306 identifies that the one or more databases closely align with the query received from the user. Per this aspect, the one or more databases serve as potential database(s) as they most likely comprise the information related to the query received from the user. It is to be appreciated that order of the one or more databases in the list is based on relevancy of industrial data in the one or more databases to the query received from the user. That is, a database with industrial data that is of highest relevance to the query received from the user will be at the top of the list, while another database with industrial data that is of least relevance to the query received from the user will be at the bottom of the list.

Further, in one or more example embodiments described herein, the data mapping engine 306 retrieves the information from the one or more databases. It is to be appreciated that the information retrieved from the one or more databases often corresponds to conglomeration of industrial data relevant to the query from each of the one or more databases which are disparate in nature. Then, the data mapping engine 306 frames a plurality of responses based on the information in the one or more databases. Upon framing the plurality of responses, the data mapping engine 306 validates the plurality of responses to the query even before providing response(s) to the user. Upon validation, the data mapping engine 306 chooses one or more responses from amongst the plurality of responses. This is to make sure that the one or more responses from the data management system 300 are of utmost accuracy. Also, such validation potentially avoids situations like hallucinations. Upon validation, in one or more example embodiments, the data mapping engine 306 facilitates rendering of the one or more responses to the query received from the user via the user interface 308. Also, the data mapping engine 306 makes sure to store the query received from the user and/or the one or more responses in suitable storage(s) as well. In this regard, the data management system 300 maintains history of queries received from the user along with their corresponding responses in suitable storage(s). Also, the data management system 300 learns from such history over time to improvise quality of responses which can be provided to users associated with the facility. Thus, the foregoing vector-based data classification and data retrieval approach enables efficient and accurate identification of relevant database(s) to facilitate improved querying experience for users in the facility. By focusing on vectorization, the data management system 300 avoids the need for processing large amounts of data and effectively streamlines classification of user queries in multi-database environments which are disparate in nature.

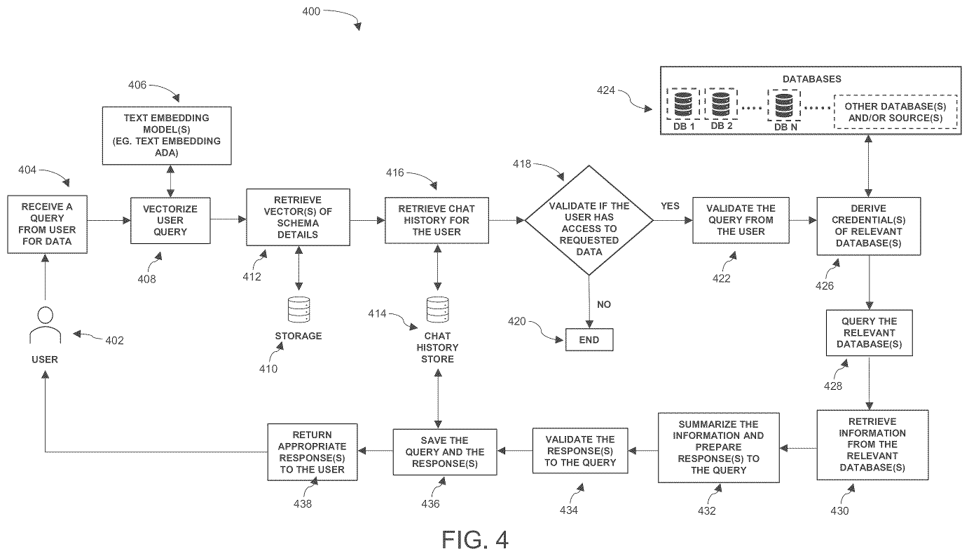

FIG. 4 illustrates a schematic diagram showing an exemplary flow diagram associated with one or more operations of exemplary data management system, in accordance with one or more example embodiments described herein. In one or more example embodiments, the exemplary flow 400 described herein illustrates steps or operations that are performable using the data management system 300 which is described in accordance with FIG. 3 of the current disclosure. That is, the exemplary flow 400 described herein illustrates steps or operations which facilitate a user 402 to retrieve relevant industrial data from disparate databases using the data management system 300. At block 404, the data management system 300 receives a query from the user 402 via the user interface 308. The query may often correspond to a specific ask for industrial data associated with the facility. Also, the query may be related to particular assets and/or particular processes in the facility. Upon receipt of such query from the user 402, the data management system 300 at block 408 vectorizes the query. In this regard, the data management system 300 relies on text embedding model(s) (such as, but not limited to text embedding ADA model) shown at block 406 to vectorize the query in a manner which is described in accordance with FIG. 3 of the current disclosure. Then, at block 412 the data management system 300 retrieves vector(s) of schema details of databases associated with the facility. These databases often correspond to disparate databases which store all industrial data associated with the facility in a distributed manner which is described in accordance with FIG. 3 of the current disclosure. The data management system 300 may retrieve such vector(s) from a storage 410. Further, the data management system 300 retrieves chat history at block 416 for the user 402 from chat history store 414. The chat history may comprise one or more historical queries received from the user 402 along with one or more historical responses provided by the data management system 300 to the corresponding one or more historical queries. It is to be appreciated that the data management system 300 may maintain the chat history store 414 by regularly storing appropriate queries received from users and/or appropriate responses provided to the queries. Also, the data management system 300 may update the chat history store 414 on a periodic basis.

Then, the data management system 300 at block 418 validates if the user 402 has access to the requested data. This validation is done to make sure that only authorized personnel are provided with relevant industrial data. If the user 402 has the required access, the data management system 300 proceeds to validate the received query at block 422. If the user 402 does not have the required access, the data management system 300 terminates the flow 400 as illustrated at block 420. The data management system 300 validates the received query at block 422 to make sure that the query pertains to ask/request for industrial data associated with the facility. Upon validating the query, the data management system 300 at block 426 derives credential(s) of relevant database(s) which are deemed to comprise information relevant to the ask/request for industrial data from the user 402. The relevant database(s) which are deemed to comprise the information are shortlisted from databases shown at block 424. Further, the data management system 300 queries the relevant database(s) at block 428. Based on this, the data management system 300 retrieves the information from the relevant database(s) at block 430 in a manner which is described in accordance with FIG. 3 of the current disclosure. Upon retrieval of the information, the data management system 300 summarizes the information and prepares response(s) to the query at block 432 in a manner which is described in accordance with FIG. 3 of the current disclosure. Additionally, the data management system 300 validates the response(s) to the query at block 434 in a manner which is described in accordance with FIG. 3 of the current disclosure. The data management system 300 also makes sure at block 436 to store the query received from the user 402 and the response(s) to the query in the chat history store 414. Based on the validation, the data management system 300 at block 438 returns appropriate response(s) to the user 402. The appropriate response(s) are selected from the response(s) based on the validation. This is to make sure that the appropriate response(s) are of utmost accuracy and correspond to the relevant industrial data which is desired by the user 402.

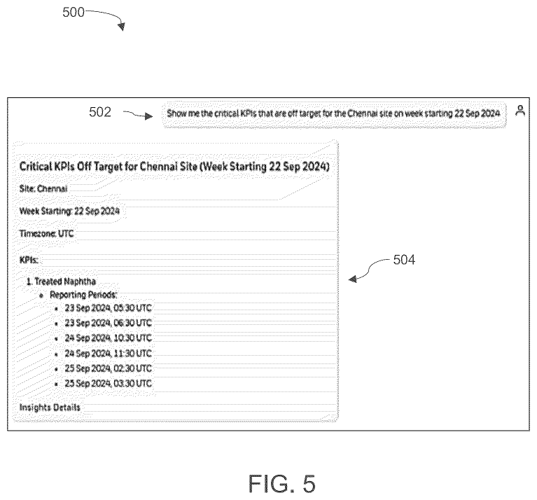

FIG. 5 illustrates a schematic diagram showing an exemplary user interface associated with an exemplary data management system, in accordance with one or more example embodiments described herein. The exemplary user interface 500 described herein corresponds to an exemplary chat interface that allows users associated with the facility to interact with the data management system 300 which is described in accordance with FIG. 3 of the current disclosure. A user associated with a specific site initially provides a query 502 via the interface 500. The query 502 may be related to particular assets and/or particular processes in the site. As illustrated in FIG. 5, the exemplary query 502 relates to key performance indicators (KPIs) for the specific site. In response to the user providing such a query, the data management system 300 converts representations in the query 502 into a second vectorial representation in a manner which is described in accordance with FIG. 3 of the current disclosure. Then, the data management system 300 compares the second vectorial representation against each of one or more first vectorial representations of a plurality of disparate databases associated with the site in a manner which is described in accordance with FIG. 3 of the current disclosure. Upon comparison, the data management system 300 generates a ranked list of one or more databases from amongst the plurality of disparate databases in a manner which is described in accordance with FIG. 3 of the current disclosure. Then, the data management system 300 renders a response 504 via the interface 500 to the query 502 received from the user. To provide the response 504, the data management system 300 initially retrieves information from the one or more databases associated with the site, frames a plurality of responses based on the retrieved information, and validates the plurality of responses to choose the response 504 as the best response to the query 502. It is to be noted that the data management system 300 may receive one or more follow up queries from the user upon rendering the response 504 via the interface 500. Per this aspect, the one or more follow up queries may or may not be related to the query 502 and/or the response 504.

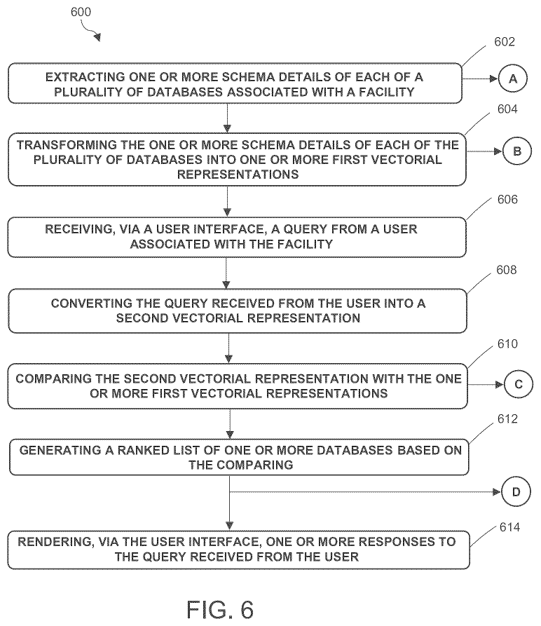

FIG. 6 illustrates a flowchart showing a method described in accordance with one or more example embodiments described herein. In this regard, FIG. 6 illustrates operations that may be performed using the data management system 300. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600. At step 602 of the exemplary flowchart 600, the data management system 300 comprises means such as, the data classification module 304 to extract one or more schema details of each of a plurality of databases associated with a facility. At step 604 of the exemplary flowchart 600, the data management system 300 comprises means such as, the data classification module 304 to transform the one or more schema details of each of the plurality of databases into one or more first vectorial representations. At step 606 of the exemplary flowchart 600, the data management system 300 comprises means such as, the user interface 308 to receive a query from a user associated with the facility. At step 608 of the exemplary flowchart 600, the data management system 300 comprises means such as, the data classification module 304 to convert the query received from the user into a second vectorial representation. At step 610 of the exemplary flowchart 600, the data management system 300 comprises means such as, the data mapping engine 306 to compare the second vectorial representation with the one or more first vectorial representations. At step 612 of the exemplary flowchart 600, the data management system 300 comprises means such as, the data mapping engine 306 to generate a ranked list of one or more databases based on the comparing. In this regard, the data mapping engine 306 identifies that the one or more databases comprise information related to the query received from the user based on one or more similarity scores. At step 614 of the exemplary flowchart 600, the data management system 300 comprises means such as, the user interface 308 to render one or more responses to the query received from the user. In this regard, the data mapping engine 306 provides the one or more responses based on the information in the one or more databases. Also, it is to be noted that the data management system 300 makes sure to store the one or more responses to the query received from the user.

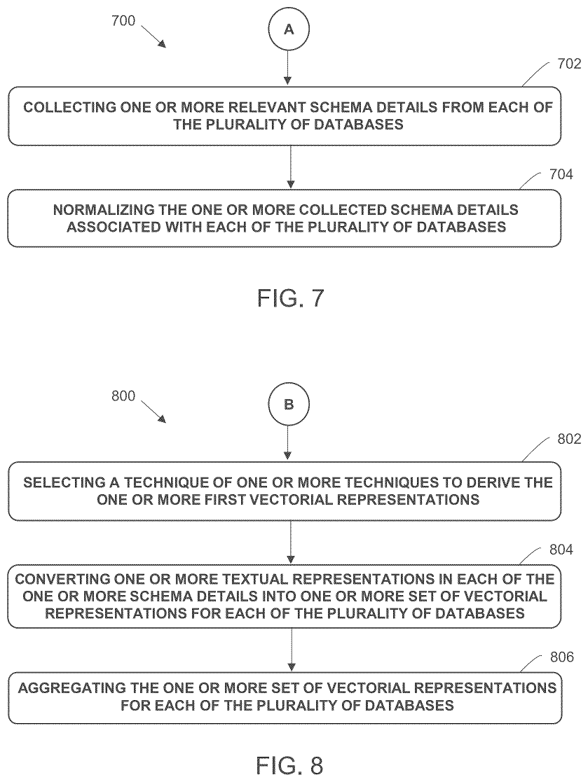

FIG. 7 illustrates a flowchart showing a method described in accordance with one or more example embodiments described herein. In this regard, FIG. 7 illustrates operations that may be performed using the data management system 300. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700. At step 702 of the exemplary flowchart 700, the data management system 300 comprises means such as, the data classification module 304 to collect one or more relevant schema details from each of the plurality of databases. At step 704 of the exemplary flowchart 700, the data management system 300 comprises means such as, the data classification module 304 to normalize the one or more collected schema details associated with each of the plurality of databases.

FIG. 8 illustrates a flowchart showing a method described in accordance with one or more example embodiments described herein. In this regard, FIG. 8 illustrates operations that may be performed using the data management system 300. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800. At step 802 of the exemplary flowchart 800, the data management system 300 comprises means such as, the data classification module 304 to select a technique of one or more techniques to derive the one or more first vectorial representations. At step 804 of the exemplary flowchart 800, the data management system 300 comprises means such as, the data classification module 304 to convert one or more textual representations in each of the one or more schema details into one or more set of vectorial representations for each of the plurality of databases. At step 806 of the exemplary flowchart 800, the data management system 300 comprises means such as, the data classification module 304 to aggregate the one or more set of vectorial representations for each of the plurality of databases.

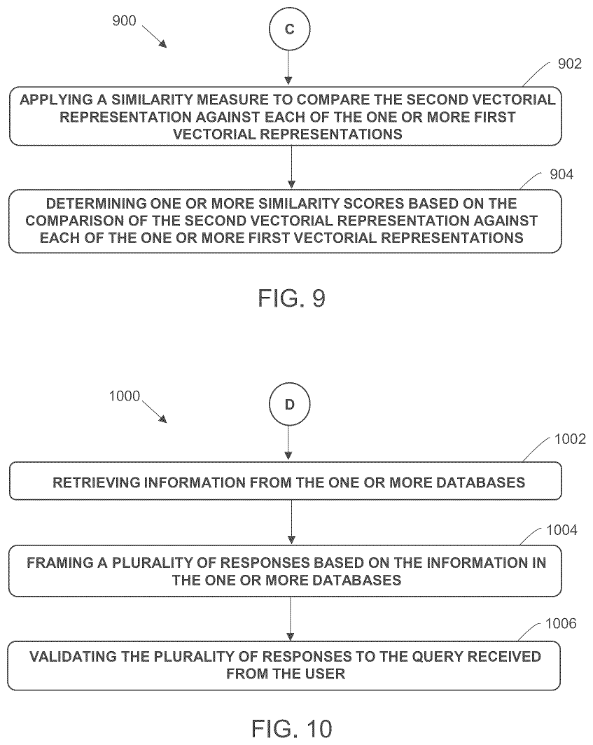

FIG. 9 illustrates a flowchart showing a method described in accordance with one or more example embodiments described herein. In this regard, FIG. 9 illustrates operations that may be performed using the data management system 300. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900. At step 902 of the exemplary flowchart 900, the data management system 300 comprises means such as, the data mapping engine 306 to apply a similarity measure to compare the second vectorial representation against each of the one or more first vectorial representations. At step 904 of the exemplary flowchart 900, the data management system 300 comprises means such as, the data mapping engine 306 to determine one or more similarity scores based on the comparison of the second vectorial representation against each of the one or more first vectorial representations.

FIG. 10 illustrates a flowchart showing a method described in accordance with one or more example embodiments described herein. In this regard, FIG. 10 illustrates operations that may be performed using the data management system 300. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000. At step 1002 of the exemplary flowchart 1000, the data management system 300 comprises means such as, the data mapping engine 306 to retrieve the information from the one or more databases. At step 1004 of the exemplary flowchart 1000, the data management system 300 comprises means such as, the data mapping engine 306 to frame a plurality of responses based on the information in the one or more databases. At step 1006 of the exemplary flowchart 1000, the data management system 300 comprises means such as, the data mapping engine 306 to validate the plurality of responses to the query received from the user.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation. It is intended that the specification and examples be considered as exemplary only, with a true scope and spirit of the disclosure being indicated by the following claims.

1. A method for managing classification and retrieval of data associated with a facility, the method comprising:
extracting one or more schema details of each of a plurality of databases associated with the facility, wherein the plurality of databases stores industrial data related to one or more assets of the facility;
normalizing the one or more schema details associated with each of the plurality of databases to ensure consistency of schema details across the plurality of databases, wherein the plurality of databases comprises disparate databases;
transforming the one or more schema details of each of the plurality of databases into one or more first vectorial representations using a selected text embedding technique;
receiving, via a user interface, a query from a user associated with the facility. wherein the query is related to the one or more assets of the facility;
retrieving a chat history associated with the user, wherein the chat history comprises one or more historical queries received from the user and one or more historical responses corresponding to the one or more historical queries;
converting the query received from the user into a second vectorial representation based at least in part on the retrieved chat history;
comparing the second vectorial representation with the one or more first vectorial representations using the selected text embedding technique, wherein the second vectorial representation is semantically compared against each of the one or more first vectorial representations to determine a degree of semantic similarity between the second vectorial representation and a corresponding first vectorial representation with which the second vectorial representation is compared ;
generating a ranked list of one or more databases based on the comparing, wherein the one or more databases comprise information related to the query received from the user; and
rendering, via the user interface, one or more responses to the query received from the user, wherein the one or more responses are based on the information in the one or more databases.

2. The method of claim 1, wherein extracting the one or more schema details comprises:
collecting one or more relevant schema details from each of the plurality of databases, wherein the one or more collected schema details for each database comprises one or more table names, one or more column names, one or more data types, and one or more schema descriptions; and
normalizing the one or more collected schema details associated with each of the plurality of databases.

3. The method of claim 1, wherein transforming the one or more schema details into one or more first vectorial representations comprises:
selecting a technique of one or more techniques to derive the one or more first vectorial representations;
converting one or more textual representations in each of the one or more schema details into one or more set of vectorial representations for each of the plurality of databases; and
aggregating the one or more set of vectorial representations for each of the plurality of databases.

4. The method of claim 1, wherein comparing the second vectorial representation with the one or more first vectorial representations:
applying a similarity measure to compare the second vectorial representation against each of the one or more first vectorial representations, wherein the similarity measure corresponds to cosine similarity; and
determining one or more similarity scores based on the comparison of the second vectorial representation against each of the one or more first vectorial representations.

5. The method of claim 4, wherein generating the ranked list of the one or more databases comprises:
identifying that the one or more databases comprise the information related to the query received from the user based on the one or more similarity scores.

6. The method of claim 1, further comprising:
retrieving the information from the one or more databases;
framing a plurality of responses based on the information in the one or more databases; and
validating the plurality of responses to the query received from the user.

7. The method of claim 1, further comprising storing the one or more responses to the query received from the user.

8. A system for managing classification and retrieval of data associated with a facility, the system comprising:
a processor;
a memory communicatively coupled to the processor, wherein the memory comprises one or more instructions which when executed by the processor, cause the processor to:
extract one or more schema details of each of a plurality of databases associated with the facility, wherein the plurality of databases stores industrial data related to one or more assets of the facility;
normalize the one or more schema details associated with each of the plurality of databases to ensure consistency of schema details across the plurality of databases, wherein the plurality of databases comprises disparate databases;
transform the one or more schema details of each of the plurality of databases into one or more first vectorial representations using a selected text embedding technique;
receive, via a user interface, a query from a user associated with the facility, wherein the query is related to the one or more assets of the facility;
retrieve a chat history associated with the user, wherein the chat history comprises one or more historical queries received from the user and one or more historical responses corresponding to the one or more historical queries;
convert the query received from the user into a second vectorial representation based at least in part on the retrieved chat history;
compare the second vectorial representation with the one or more first vectorial representations using the selected text embedding technique, wherein the second vectorial representation is semantically compared against each of the one or more first vectorial representations to determine a degree of semantic similarity between the second vectorial representation and a corresponding first vectorial representation with which the second vectorial representation is compared;
generate a ranked list of one or more databases based on the comparing, wherein the one or more databases comprise information related to the query received from the user; and
render, via the user interface, one or more responses to the query received from the user, wherein the one or more responses are based on the information in the one or more databases.

9. The system of claim 8, wherein the processor is further configured to:
collect one or more relevant schema details from each of the plurality of databases, wherein the one or more collected schema details for each database comprises one or more table names, one or more column names, one or more data types, and one or more schema descriptions; and
normalize the one or more collected schema details associated with each of the plurality of databases.

10. The system of claim 8, wherein the processor is further configured to:
select a technique of one or more techniques to derive the one or more first vectorial representations;
convert one or more textual representations in each of the one or more schema details into one or more set of vectorial representations for each of the plurality of databases; and
aggregate the one or more set of vectorial representations for each of the plurality of databases.

11. The system of claim 8, wherein the processor is further configured to:
apply a similarity measure to compare the second vectorial representation against each of the one or more first vectorial representations, wherein the similarity measure corresponds to cosine similarity; and
determine one or more similarity scores based on the comparison of the second vectorial representation against each of the one or more first vectorial representations.

12. The system of claim 11, wherein the processor is further configured to identify that the one or more databases comprise the information related to the query received from the user based on the one or more similarity scores.

13. The system of claim 8, wherein the processor is further configured to:
retrieve the information from the one or more databases;
frame a plurality of responses based on the information in the one or more databases; and
validate the plurality of responses to the query received from the user.

14. The system of claim 8, wherein the processor is further configured to store the one or more responses to the query received from the user.

15. A non-transitory, computer-readable storage medium having stored thereon executable instructions that, when executed by one or more processors, cause the one or more processors to:
extract one or more schema details of each of a plurality of databases associated with a facility, wherein the plurality of databases stores industrial data related to one or more assets of the facility;
normalize the one or more schema details associated with each of the plurality of databases to ensure consistency of schema details across the plurality of databases, wherein the plurality of databases comprises disparate databases;
transform the one or more schema details of each of the plurality of databases into one or more first vectorial representations using a selected text embedding technique;
receive, via a user interface, a query from a user associated with the facility, wherein the query is related to the one or more assets of the facility;
retrieve a chat history associated with the user, wherein the chat history comprises one or more historical queries received from the user and one or more historical responses corresponding to the one or more historical queries;
convert the query received from the user into a second vectorial representation based at least in part on the retrieved chat history;
compare the second vectorial representation with the one or more first vectorial representations using the selected text embedding technique, wherein the second vectorial representation is semantically compared against each of the one or more first vectorial representations to determine a degree of semantic similarity between the second vectorial representation and a corresponding first vectorial representation with which the second vectorial representation is compared;
generate a ranked list of one or more databases based on the comparing, wherein the one or more databases comprise information related to the query received from the user; and
render, via the user interface, one or more responses to the query received from the user, wherein the one or more responses are based on the information in the one or more databases.

16. The non-transitory, computer-readable storage medium of claim 15, wherein the one or more processors is further configured to:
collect one or more relevant schema details from each of the plurality of databases, wherein the one or more collected schema details for each database comprises one or more table names, one or more column names, one or more data types, and one or more schema descriptions; and
normalize the one or more collected schema details associated with each of the plurality of databases.

17. The non-transitory, computer-readable storage medium of claim 15, wherein the one or more processors is further configured to:
select a technique of one or more techniques to derive the one or more first vectorial representations;
convert one or more textual representations in each of the one or more schema details into one or more set of vectorial representations for each of the plurality of databases; and
aggregate the one or more set of vectorial representations for each of the plurality of databases.

18. The non-transitory, computer-readable storage medium of claim 15, wherein the one or more processors is further configured to:
apply a similarity measure to compare the second vectorial representation against each of the one or more first vectorial representations, wherein the similarity measure corresponds to cosine similarity; and
determine one or more similarity scores based on the comparison of the second vectorial representation against each of the one or more first vectorial representations.

19. The non-transitory, computer-readable storage medium of claim 18, wherein the one or more processors is further configured to identify that the one or more databases comprise the information related to the query received from the user based on the one or more similarity scores.

20. The non-transitory, computer-readable storage medium of claim 15, wherein the one or more processors is further configured to:
retrieve the information from the one or more databases;
frame a plurality of responses based on the information in the one or more databases; and
validate the plurality of responses to the query received from the user.
